(19) United States
(12) Patent Application Publication
(10) Pub. No.: US 2012/0150579 A1
(43) Pub. Date: Jun. 14, 2012

(54) WORK DISTRIBUTION SYSTEM AND METHOD OF DISTRIBUTING WORK

(75) Inventor: Danny de Wit, Rotterdam (NL)

(73) Assignee: EXVO.COM COMPANY B.V., Rotterdam (NL)

(21) Appl. No.: 12/963,108

(22) Filed: Dec. 8, 2010

(51) Int. Cl. G06Q 10/00

(52) U.S. Cl. 705/7.14; 705/7.13

(57) ABSTRACT

In a work distribution system and a method of distributing work, a plurality of task objects is made available for a future employer to browse and claim. Each task object represents work to be carried out for a particular employer. The availability of a task object to a future worker is delayed by a predetermined time period after creating and/or modifying the task object in dependence of a determined employer ranking order of the task object among the plurality of task objects.

### TECHNICAL FIELD

The present invention is related to a work distribution system and to a method of distributing work. Such systems and methods are targeted at distributing the work from a plurality of employers to a plurality of workers.

### BACKGROUND

An example of such a system comprises a website being hosted on a remote server. Employers can log onto the website and publish tasks on the website for future workers. These tasks, hereinafter referred to as task objects, comprise a task description and some indication regarding the price. A future worker can bid on this task by supplying a work price for which that worker wants to do the work involved. Finally, the employer can choose the future worker he wishes to entrust with the work. This process is normally driven mainly by the price.

A drawback of such system is that the employer has little to no information regarding the qualifications or capabilities of the future worker. If such information is given at all, it is normally drafted by the worker. This implies that it is difficult for a worker to distinguish himself from other workers. Most likely, every worker will exaggerate his qualifications in order not to place himself in a bad position.

Another drawback of such a system is that it disregards other aspects besides the price. For instance, an employer may wish to have the work done on short notice. Such aspect is only reflected in the task description. The uncertainty whether this work is accepted by a future worker is purely on the side of the employer as a worker can easily compare between different task objects. For example, a worker is never confronted with doubt whether to accept a task object relating to work that has to be carried out on short notice because he can easily determine his position by comparing to other task objects.

It may desirable to provide a work distribution system providing an alternative to the known work distribution systems wherein the abovementioned drawbacks do not occur or at least to a lesser degree.

### SUMMARY

The work distribution system according to the invention comprises an employer module that is remotely controllable by an employer, wherein the employer module has a task object unit for creating and/or modifying a task object that corresponds to work to be carried out for the employer by a future worker.

Normally multiple task objects are created by a plurality of different employers. This plurality of task objects is stored in a task database which itself is comprised by an employer database.

The employer database further comprises a task attribute database for storing at least one task attribute and corresponding task attribute value for each of the plurality of employers. Here, one of the at least one task attribute is a task price related to a task object created or to be created by said task object unit and the corresponding task attribute value is the magnitude of the task price.

A worker module is provided that is remotely controllable by a future worker. This module comprises a browse/select unit which a future worker can use for browsing the task database. If the future worker finds a task object related to work he is interested in doing, the worker may claim that task object to indicate that he will carry out the work associated with the claimed task object.

The employer module comprises an employer ranking unit that is arranged to determine an employer ranking order for each task price in the task attribute database using an employer ranking algorithm in dependence of the magnitude of the task price. For instance, a task attribute database may comprise three task prices A, B, and C. The employer ranking unit then determines the employer ranking order for A, B, and C based on the magnitude of the price. A possible employer ranking order could be A, C, B, if A has the highest price and B the lowest.

The employer module further comprises a task access unit that is arranged to delay the availability of a task object in the task database to a future worker by a predetermined time period after creating and/or modifying the task object in dependence of the determined employer ranking order. Hence, generating task objects at the same time does not imply that these objects are made available for future workers to claim at the same moment.

In a situation where three similar task objects are generated although related to a different price setting, it becomes possible to make the task object with the highest associated price available first, giving the relevant employer a time advantage. Because the task objects related to the highest prices are made available first, future workers have less task objects to compare. These task objects could well have aspects that are less appealing to a future worker. However, the future worker cannot compare this task object with all the created task objects as some are not yet available. He is therefore confronted with the dilemma whether he should accept the task object with the high price and the less appealing other features or if he should wait for another task object thereby risking loosing the already available task object to another future worker. In this way, the entire process of accepting and publishing work is different than with prior art systems.

The task attribute database and task database can be merged into a single task database, wherein each task object in the task database comprises a task description and said at least one task attribute with corresponding task attribute value.

An example of a task object could be the construction of a fence. The task description of the task object could contain the specifics regarding place, size, and materials to be used. The price is an example of a task attribute, wherein the task attribute value is the actual price, e.g. 100 dollar.

The employer module may comprise a task timer enabling the task object unit to determine the time and date of creation/modification of the task object. The task access unit can be configured to calculate the delay based on the employer ranking order received from the employer ranking unit. Furthermore, it can determine whether or not to provide access for the future worker to the task object based on the calculated delay, the time and date of creation/modification of the task object, and a current time and date received from the task timer. The task access unit can therefore determine whether the making available of a task object to a future worker has been delayed enough in correspondence with the determined employer ranking order. It should be noted that the information regarding the time and date of creation/modification of the task object can be stored in the task object itself, in the form of a task attribute and associated task attribute value, or this information is sent from the task object unit to the task access unit. It should be apparent to the skilled person that such information can be obtained in other ways as well.

The employer module may be configured to provide information regarding the determined employer ranking order to the relevant employer, and to allow the relevant employer to change the at least one task attribute and/or corresponding task attribute value. For instance, if the sole task attribute is the task price, the employer could increase the magnitude of the task price, i.e. the task attribute value for the task attribute task price, to try and improve the employer ranking order.

Instead of task price, another task attributes can be used for determining the employer ranking order. Furthermore, the present invention is not limited to determining the employer ranking order based on a single common task attribute, in particular the task price.

The employer ranking unit can be arranged to determine the employer ranking order using an employer ranking algorithm in dependence of a plurality of task attribute values corresponding to a plurality of task attributes that are common to each of said plurality of employers. In this case, the employer ranking algorithm is configured to determine a separate employer ranking order for each of the common task attributes using the corresponding task attribute values and to determine the employer ranking order by weighing each separate employer ranking order according to a predefined weighing scheme.

For example, the task attribute database could comprise two task attributes that are common to each of the plurality of employers. An employer ranking order can then be determined for each of the common task attributes. In order to determine the employer ranking order used for calculating the delay of the availability of a task object generated by one of the plurality of employers, the separate employer ranking orders can be weighed. For instance, the task attribute price could be counted twice with respect to a task attribute experience. Therefore, in this example, the task access unit uses a single employer ranking order as input to calculate the appropriate delays for the various task objects.

The employer ranking unit can also be arranged to determine the employer ranking order using an employer ranking algorithm in dependence of a plurality of task attribute values corresponding to a plurality of task attributes that are common to each of said plurality of employers, wherein the employer ranking algorithm is configured to determine a separate employer ranking order for each of the common task attributes using the corresponding task attribute values. However, in this embodiment, the access unit is arranged to determine a separate predetermined time period for each common task attribute in dependence of the relevant separate employer ranking order. The access unit is then arranged to delay the availability of a task object in the task database to a future worker by the sum of the separate predetermined time periods after creating and/or modifying the task object. In this embodiment, the access unit therefore uses multiple employer ranking orders corresponding to different common task attributes to calculate the delay. The calculation of the predetermined time period could depend on the task attribute involved or it could be independent thereof.

Both examples above are possible ways to take into account multiple task attributes when determining the employer ranking order. Consequently, an employer has more degrees of freedom when he wishes to improve his position other than adjusting the task price.

The task access unit can be configured to calculate the delay from the time and date of creating the task object by the task object unit. Alternatively or additionally, the time and date of modification are taken into account. This may result in a system where, following a modification of the task price task attribute value by an employer to improve the employer ranking order, the delay is taken from the time and date of modification and not the time and date of creation of the original task object.

The task price preferably corresponds to the amount of money the relevant employer will pay to a receipt intermediary for carrying out the work by the future worker. The employer ranking order is usually determined to be higher when the task price is higher than those corresponding to other employers. The delay in making the task object available to a future worker normally decreases with increasing employer ranking order. This allows an employer to increase the task price should he wish to have his task object available to future workers first.

The work distribution system may comprise a database with available predefined task attributes, wherein the employer module is arranged for allowing the employer to select a task attribute from the database of available predefined task attributes, to assign a task attribute value to the selected task attribute, to assign the selected task attribute and corresponding task attribute value to the employer, and to place the selected task attribute and task attribute value as an entry in the task attribute database. Using predefined task attributes enables a homogenous representation of task attributes by the various employers. Nevertheless, this does not exclude a system in which new task attributes are created in response to a request from an employer or a future worker.

The database of available predefined task attributes may comprise at least one of the group consisting of a location, being the location at which the work has to be carried out, experience, being the amount of previous task objects claimed by a future worker, a skill level, representing the desired capabilities of a future worker pertaining to a given skill, a time and date of creation/modification of a task object, a delivery time, indicating at what time and date the work should be finished, and an account type, indicating whether the employer has a paid account for using the work distribution system. Other task attributes are not excluded by this list.

The worker module may comprise a worker profile unit for creating a worker profile comprising at least one worker attribute with a corresponding worker attribute value. The work distribution system may further comprise a worker database for storing a plurality of worker profiles corresponding to a plurality of workers. One of the at least one worker attribute is a work price related to the work to be carried out, wherein the corresponding worker attribute value is the magnitude of the work price.

The worker module may further comprise a worker ranking unit arranged to determine a worker ranking order for each work price in the worker database using a worker ranking algorithm in dependence of the magnitude of the work price. In addition, the worker module may comprise a worker access unit arranged to delay the availability of a task object in the task database to a future worker by a predetermined time period in dependence of the determined worker ranking order. These measures trigger competition between future workers in a similar manner as between employers.

The worker module may comprise a worker timer. Furthermore, the worker access unit may be configured to calculate the delay based on the worker ranking order received from the worker ranking unit. In addition, the worker access unit may determine whether or not to provide access for the future worker to the task object based on the calculated delay, the time and date of creation/modification of the task object, and a current time and date received from the worker timer. The time and date of creation/modification of the task object may be taken from the task object itself when this information is present therein. However, a direct communication between the task object unit and the worker access unit to convey this information is not excluded.

The worker module may be configured to provide information regarding the determined worker ranking order to the future worker, and to allow the future worker to change the at least one worker attribute and/or corresponding worker attribute value.

The worker ranking unit may be arranged to determine the worker ranking order using a worker ranking algorithm in dependence of a plurality of worker attribute values corresponding to a plurality of worker attributes that are common to each of the plurality of workers. The worker ranking algorithm can be configured to determine a separate worker ranking order for each of the common worker attributes using the corresponding worker attribute values and to determine the worker ranking order by weighing each separate worker ranking order according to a predefined weighing scheme.

The worker ranking unit can also be arranged to determine the worker ranking order using a worker ranking algorithm in dependence of a plurality of worker attribute values corresponding to a plurality of worker attributes that are common to each of said plurality of workers. The worker ranking algorithm can be configured to determine a separate worker ranking order for each of the common worker attributes using the corresponding worker attribute values. However, in this case the worker access unit can be arranged to determine a separate predetermined time period for each common worker attribute in dependence of the relevant separate worker ranking order. Furthermore, the worker access unit can be arranged to delay the availability of a task object in the task database to a future worker by the sum of the separate predetermined time periods after creating and/or modifying the task object.

Up to now, two different delays have been described, a task delay introduced by the task access unit and a worker delay introduced by the worker access unit. The total delay computed from the time of creating the task object and a future worker being able to claim the task object can be the sum of these two delays.

The work distribution system may further comprise a worker attribute database with predefined worker attributes. This allows a homogenous presentation of different worker profiles similar to the task attribute database. The worker module can be arranged for selecting a worker attribute from the worker attribute database, for assigning a worker attribute value to the selected worker attribute, and for incorporating the worker attribute and worker attribute value assigned thereto into the worker profile.

The worker attribute database may comprise at least one of the group consisting of a location, being a location at which the work can be carried out by the future worker, experience, being the amount of previous task objects carried out by the future worker, availability, to indicate at what point in time a future worker is available, and an account type, indicating whether the future worker has a paid account for using the work distribution system.

The work distribution system may further comprise a skill database comprising skill objects representing skills needed by a future worker for carrying out the work, and/or a position database comprising job position objects representing job positions relating to the work. The employer module may comprise an employer registering unit for selecting a skill object from the skill database, and/or a job position object from the position database, and to mutually associate the objects and a created or to be created task object.

The worker module may comprise a worker registering unit for registering to a skill object from the skill database and/or for registering to a job position object from the position database. The worker access unit may be configured for making available to a future worker only those task objects for which an associated skill object and/or job position object corresponds to a skill object and/or job position object registered by the future worker. Furthermore, the task price and work price preferably correspond to the selected skill object.

The task object unit can be arranged to incorporate the selected skill object and/or job position object into the task object. Additionally or alternatively, the worker profile unit may be arranged to incorporate the registered skill object and/or job position object in the worker profile.

The worker attribute database can comprise a skill level attribute representing the current capabilities of a future worker for a given skill. Furthermore, the database with available predefined task attributes may comprise a skill level task attribute representing the desired capabilities of a future worker for a given skill object.

The worker access unit may be configured to make available to the future worker only those task objects in the task database for which the associated skill level attribute value is equal to or lower than the skill level attribute value in the worker profile. In this way, the future worker cannot see or claim task objects for which his skill level is not adequate. Moreover, an employer does not risk having his work been carried out by a future worker that does not meet the desired skill level.

The worker ranking order may be determined to be higher when the skill level attribute value pertaining to a future worker is higher than that of other future workers. Furthermore, the delay in making the task object available to a future worker may decrease with increasing worker ranking order.

The work distribution system may comprise a result collector/evaluator for evaluating work done by a future worker related to a skill object either autonomously or in response to feedback on the work obtained from the relevant employer. Autonomous evaluation could for instance be automated checking of the work based on predefined rules or based on predefined knowledge about the structure of the work. For instance, the work could be related to the translation of a piece of text having a certain amount of sections. Autonomous checking could involve checking the amount of sections and comparing that with an inputted value taken from the original text. The employer may also, alternatively or additionally, evaluate the work. This could involve checking the work by the employer himself or an affiliate. In both cases, the work evaluation can be fed back to the worker profile unit, possibly via the result collector/evaluator, which worker profile unit can be arranged to modify the skill level attribute value for that worker in dependence of the work evaluation. If a worker delivers high quality, chances are that his skill level will increase due to positive evaluations. Consequently, that worker is able to select other or more task objects from the task database.

A problem with this approach may arise when a new future worker starts to use the system. The system is normally configured such that skill level attribute values cannot be set by the future worker himself to prevent inappropriate qualifications of that future worker. Therefore, a new future worker may be assigned the lowest of skill level attribute values available. Consequently, the task objects available to him are limited. It may also be possible to assign a training status to the new future worker by the worker profile unit. A future worker who has already been assigned a skill level attribute value can delegate a task claimed by that worker to the new future worker. The worker profile unit may be configured to modify the skill level attribute value of the new future worker in dependence of a work evaluation by the future worker.

The worker ranking order can be determined higher when the work price pertaining to a future worker is lower than that of other future workers. Furthermore, the delay in making the task object available to a future worker can be made to decrease with increasing worker ranking order.

The work price is normally the amount of money the relevant worker will receive from a payment intermediary for carrying out the work. The work price is preferably not visible for the employer and/or the task price is preferably not visible for the future worker.

The worker access unit can be configured to make available to a future worker only those task objects for which the task price minus a surcharge is higher than or equal to the relevant work price pertaining to the future worker. The only way a future worker can see and claim a lower priced task object is to modify his worker profile, i.e. to lower the work price.

Alternatively or additionally, the worker module can be configured to enable the worker to claim a task object for which the task price minus a surcharge is lower than the relevant work price pertaining to the future worker. In this case, claiming the task object implies the future worker agreeing with the task price minus the surcharge as being the amount of money to receive from the payment intermediary for completing the work.

It should be apparent to the skilled person that the surcharge can also or instead be introduced on the worker side. For instance, a worker can only see and claim a particular task object if the task price minus a first surcharge is higher than or equal to the work price plus a second surcharge.

So far, two intermediaries have been discussed.

A receipt intermediary for receiving a payment from the employer, and a payment intermediary for paying the future worker for carrying out the relevant work. These two intermediaries can be the same intermediary. Moreover, the abovementioned surcharge can be for the benefit of the intermediary. Such surcharge is deemed appropriate if the intermediary is responsible for hosting, enabling, and/or facilitating the work distribution system according to the present invention.

The employer module and/or worker module can be arranged to add a new skill object to the skill database and/or a new job position object to the position database in response to a request from an employer and/or a future worker. This allows flexibility of the system. It is advantageous if such requests are handled by an administrator of the work distribution system to maintain a certain amount of consistency between the already present objects.

The worker profile unit can be configured to insert an alias for a name of the future worker into the worker profile, wherein the employer is given the alias of the future worker who has claimed a task object. In this way, the future worker can remain unknown to the employer if desired. Alternatively or additionally, the task object unit can be configured to insert an alias for a name of the employer into the task object, wherein the future worker is given the alias of the employer whose task object was claimed by the future worker instead of the real name of the employer. This allows the employer to remain unknown to the future worker.

The employer module or worker module can be configured to remove the claimed task object from the task database. In this way, other future workers can no longer claim a task object which has already been claimed.

The task object may comprise a number of available positions task attribute and an assigned a number of available positions task attribute value, wherein the employer module or worker module can be configured to reduce the number of available positions task attribute value by one each time the task object is claimed, and wherein the employer module or worker module is configured to remove the claimed task object from the task database once the number of available positions attribute value has become zero. If an employer needs several future workers to work on the same or similar task, the number of available positions task attribute enables him to place only one task object in the task database instead of needing to place multiple task objects corresponding to the amount of required future workers.

It should be noted that the abovementioned worker attribute database and the database with available predefined task attributes can be the same database.

According to another aspect of the invention, a method for distributing work is provided. This method comprises storing at least one task attribute and corresponding task attribute value for each of a plurality of employers in a task attribute database, wherein one of the at least one task attribute is a task price related to work to be carried out by a future worker for an employer and wherein the corresponding task attribute value is the magnitude of the task price. The method further comprises an employer creating and/or modifying a task object that corresponds to the work to be carried out for the employer by the future worker, and storing a plurality of task objects corresponding to a plurality of employers in a task database, wherein the task database can be browsed by a future worker and wherein a future worker can claim a task object therein to indicate that the future worker will carry out the work associated with the claimed task object. The method further comprises determining an employer ranking order for each task price in the task attribute database using an employer ranking algorithm in dependence of the magnitude of the task price, and delaying the availability of a task object in the task database to a future worker by a predetermined time period after creating and/or modifying said task object in dependence of the determined employer ranking order.

The method could further comprise providing information regarding the determined employer ranking order to the relevant employer, and allowing the relevant employer to change the at least one task attribute and/or corresponding task attribute value.

The determination of the employer ranking order could comprise determining the employer ranking order using an employer ranking algorithm in dependence of a plurality of task attribute values corresponding to a plurality of task attributes that are common to each of the plurality of employers. In this case, the employer ranking algorithm comprises the steps of determining a separate employer ranking order for each of the common task attributes using the corresponding task attribute values, and determining the employer ranking order by weighing each separate employer ranking order according to a predefined weighing scheme.

Alternatively, the determination of the employer ranking order could comprise determining the employer ranking order using an employer ranking algorithm in dependence of a plurality of task attribute values corresponding to a plurality of task attributes that are common to each of the plurality of employers. In this case, the employer ranking algorithm comprises the step of determining a separate employer ranking order for each of the common task attributes using the corresponding task attribute values. The delaying of the availability of a task object in the task database to a future worker then comprises determining a separate predetermined time period for each common task attribute in dependence of the relevant separate employer ranking order, and delaying the availability of a task object in the task database to a future worker by the sum of the separate predetermined time periods after creating and/or modifying the task object.

The method according to the invention may further comprise the employer selecting a skill object from a skill database and/or a job position object from a position database, and the employer selecting the at least one task attribute from a database with available predefined task attributes, the at least one task attribute including the task price preferably related to the selected skill object and/or job position object. The method may further comprise the employer assigning a task attribute value to the selected task attribute and storing the task attribute and the task attribute value assigned thereto in the task attribute database prior to the employer creating and/or modifying the task object. Here, the employer ranking order is determined prior to the employer creating and/or modifying said task object.

The method may further comprise the employer selecting a skill object from a skill database and/or a job position object from a position database. In addition, the employer may select the at least one task attribute from a database with available predefined task attributes, the at least one task attribute including the task price preferably related to the selected skill object and/or job position object. Then, the employer may assign a task attribute value to the selected task attribute and storing the task attribute and the task attribute value assigned thereto in the task attribute database after the employer creates and/or modifies the task object. The selected task attribute and assigned task attribute value may be incorporated into the created and/or modified task object. Subsequently, the task objects in the task database may be ranked using the employer ranking order.

The method according to the invention may further comprise the future worker creating a worker profile comprising at least one worker attribute with a corresponding worker attribute value, wherein one of the at least one worker attribute is a work price related to the work to be carried out and wherein the corresponding worker attribute value is the magnitude of the work price. A plurality of the worker profiles corresponding to a plurality of workers may be stored in a worker database. A worker ranking order can be determined for each work price in the worker database using a worker ranking algorithm in dependence of the magnitude of the work price. Subsequently, the availability of a task object in the task database to a future worker may be delayed by a predetermined time period in dependence of the determined worker ranking order.

The method may further comprise providing information regarding the determined worker ranking order to the relevant future worker, and allowing the relevant future worker to change the at least one worker attribute and/or corresponding worker attribute value.

The determination of the worker ranking order for each work price may comprise determining the worker ranking order using a worker ranking algorithm in dependence of a plurality of worker attribute values corresponding to a plurality of worker attributes that are common to each of the plurality of workers. Here, the worker ranking algorithm comprises the steps of determining a separate worker ranking order for each of the common worker attributes and to determine the worker ranking order by weighing each separate worker ranking order according to a predefined weighing scheme.

Alternatively, the determination of the worker ranking order may comprise determining the worker ranking order using a worker ranking algorithm in dependence of a plurality of worker attribute values corresponding to a plurality of worker attributes that are common to each of the plurality of workers. Here, the worker ranking algorithm comprises the step of determining a separate worker ranking order for each of the common worker attributes using the corresponding worker attribute values. The delaying of the availability of a task object in the task database to a future worker may comprise determining a separate predetermined time period for each common worker attribute in dependence of the relevant separate worker ranking order, and delaying the availability of a task object in the task database to a future worker by the sum of the separate predetermined time periods after creating and/or modifying the task object.

The method according to the invention comprises computing a total delay from the time of creating the task object till a future worker being able to claim the task object to be the sum of the delay computed in dependence of the ranking order of the task price and the delay computed in dependence of the ranking order of the work price.

The method according to the invention may further comprise the future worker registering to a skill object from the skill database and/or registering to a job position object from the position database. Then, the method can be configured such that only those task objects are made available to the future worker for which an assigned skill object and/or job position object corresponds to a registered skill object and/or job position object.

Additionally or alternatively, the method could comprise making available to the future worker only those task objects for which a task price minus surcharge is higher than or equal to the relevant work price of said future worker.

### BRIEF DESCRIPTION OF THE DRAWINGS

Next, the invention will be described in more detail under reference to the accompanying figures, wherein:

FIG. 1 illustrates an embodiment of the work distribution system according to the invention;

FIG. 2 presents a more detailed view of the employer module of the system in FIG. 1;

FIG. 3 presents a more detailed view of the worker module of the system in FIG. 1;

FIGS. 4, 5, 6 each show part of a single flow-diagram illustrating a method of distributing work according to the invention; and

FIGS. 7 and 8 each show part of a single flow-diagram illustrating a further method of distributing work according to the invention.

### DETAILED DESCRIPTION

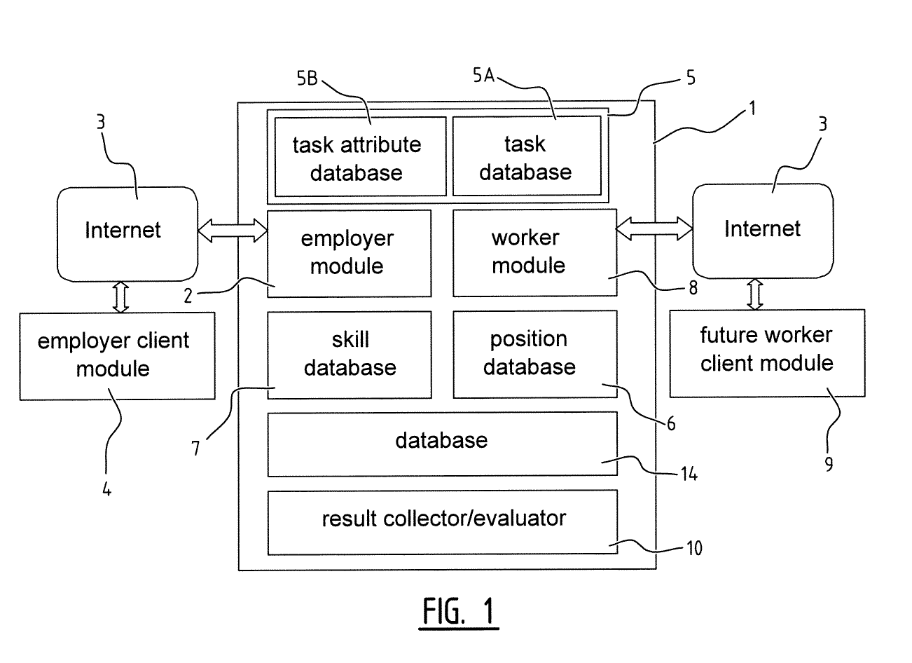

An embodiment of a work distribution system 1 according to the invention is shown in FIG. 1. It comprises an employer module 2, which is coupled via the Internet 3 to a plurality of employer client modules 4 that correspond to a plurality of employers. Using employer client module 4, a person belonging to a particular company can remotely access and/or control employer module 2 to perform a variety of functions. In particular, employer module 2 can be used to define tasks to be carried out for that employer.

Work distribution system 1 further comprises a task database 5A that comprises task objects and a task attribute database 5B comprising task attributes and task attribute values. A task object may refer to a collection of data relating to the work to be carried out for the employer by a future worker. The task object may contain a description of the work to be carried out. Task attributes may represent attributes relating to the work. Examples of task attributes are the required skill level for a given task or the task price. These task attributes, as well as the corresponding task attribute values may be incorporated into the task object. Consequently, both databases 5A, 5B can be combined into a single task database 5.

Normally, task database 5, 5A comprises a plurality of task objects corresponding to a plurality of companies/employers. Each task normally involves a particular skill and/or it relates to a particular job position. To this end, employer module 2 is able to register to a skill object from a skill database 7 and/or to a job position object from a job position database 6.

For example, a task/work could be to design a website for an employer. The relevant job position object in this case is that of a website designer. Such position requires a plurality of different skills as expressed by skill objects such as HTML programming, the ability to work with content management systems, etc. Each entry in task database 5, 5A therefore preferably lists not only a description of the task, but also the corresponding job position object(s) and/or skill object(s).

Work distribution system 1 also comprises a worker module 8 which allows a future worker to claim one or more task objects present in task database 5, 5A. To that end, a future worker can use a worker client module 9 that is connected to work distribution system 1 via the Internet 3.

To facilitate the communication of the results of the work done by the worker between employer and worker, work distribution system 1 comprises a result collector/evaluator 10. Results, for instance source code, can be uploaded by the future worker to result collector/evaluator 10, and can subsequently be downloaded by the employer.

As will be described later in more detail, work distribution system 1 controls the way in which the task objects are made available to the future worker and/or the way in which a future worker can claim a task object. This process can be based inter alia on the skill level of a future worker. If a particular skill level is required by an employer for carrying out a particular task, only those future workers that function at that level will preferably be able to acquire or claim that task.

Once a task is completed, the work done by the worker can be reviewed on quality, either by the employer responsible for placing the task object and/or by an automated process. The outcome of this evaluation can subsequently be used to update the skill level of the relevant worker. This stimulates a worker to constantly deliver work at high quality. The evaluation process could comprise the employer providing feedback to worker module 8, which in turn updates the skill level of the worker if needed. Result collector/evaluator 10 may also perform the abovementioned automated process to provide additional or alternative data regarding the quality of the delivered work used for updating the skill level.

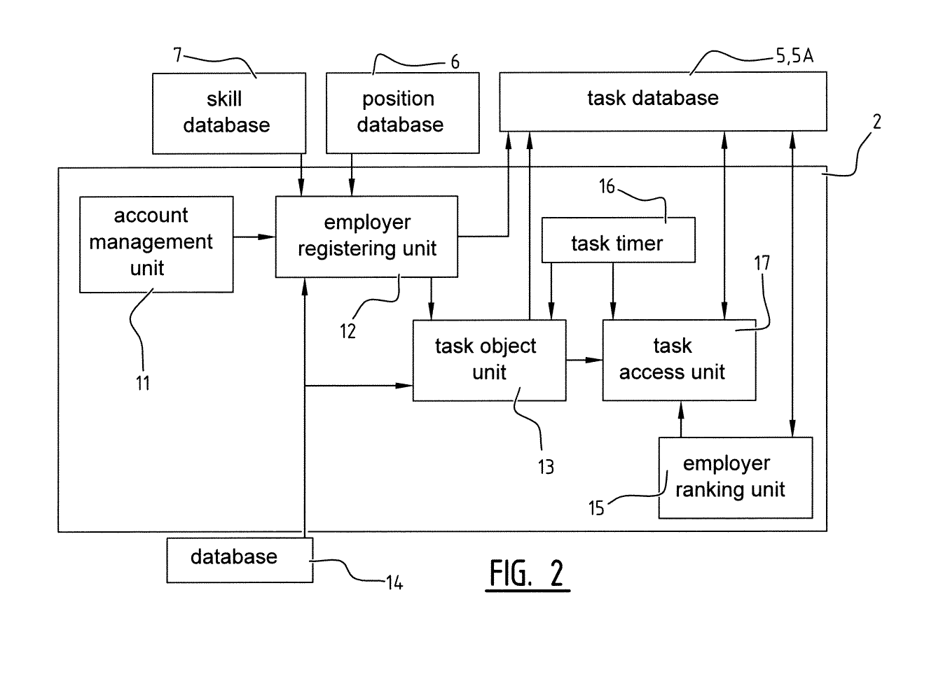

FIG. 2 illustrates employer module 2 in more detail. It comprises an account management unit 11 that an employer/company can use to perform several account management operations. For example, an employer can generate an account with work distribution system 1 and/or alter the particulars of such an account, e.g. address, name, billing information, etc. The name used on work distribution system 1 need not correspond to the actual name of the employer. In this way, anonymity can be achieved when needed. Furthermore, account management unit 11 can be used to log into work distribution system 1.

Once an employer is logged in, an employer registering unit 12 can be used to select a particular skill object and/or job position object. To that end, employer module 2 can access position database 6 and skill database 7.

According to an embodiment of the present invention, the employer can subsequently associate task attributes and task attribute values to the selected skill object or job position object. To that end, the employer can select or pick the task attributes from a database 14 having predefined task attributes. An important example of such a task attribute is the task price. For instance, after registering to the skill object of translating from Dutch to English, the employer could be asked to input the task price for that skill object. In other words, the employer is asked to supply the task attribute value, i.e. the magnitude of the task price for instance 10 dollar cents per word. Other examples of task attributes are the skill level and/or experience required for the skill or job position, the maximum amount of errors that is allowed, or the period in which the task/work must be completed.

The task attribute and corresponding task attribute value, e.g. task price and its magnitude, are placed in the task attribute database 5B or in the merged task database 5.

After the employer has associated one or more task attributes to a skill object and/or job position object, he may proceed with defining a task object using task object unit 13.

In the abovementioned situation, task attributes are associated with a skill object and/or a job position object. In another embodiment, this association is more indirect. Then, an employer defines a task object and associates a skill object and/or a job position object to the task object. Still, task attributes and task attribute values can be assigned to the skill object and/or job position object and may even well be incorporated in the task object. In other embodiments, the task attributes and task attribute values do not relate to any skill object and/or job position object. It may even be that the task attributes only relate to a particular task object. In any event, task attributes are stored in the task attribute database 5, 5B.

Once the task object is created it is put in task database 5A, 5. The selected skill object and/or job position object could be incorporated in the task object as well. However, putting the task object in task database 5, 5A does not necessarily imply that the contents of this database are accessible by future workers. Instead, an employer ranking unit 15, a task timer 16, and a task access unit 17 are used to intentionally postpone the moment at which the newly created and/or updated task object becomes accessible for future workers.

Employer ranking unit 15 determines an employer ranking order for each task price in the task attribute database 5, 5B. It may do so once a task object is created and the task price is incorporated in the task object or prior to creation of a task object. In the latter case, an employer normally first specifies the skills (objects) needed for the task object to be created and the task price associated with those skills. The task price is then compared to other task prices, relating to the same skill, in task attribute database 5, 5B.

Employer ranking unit 15 compares the task attribute values, and the task price as particular example, in task attribute database 5, 5B using an employer ranking algorithm. The employer ranking algorithm takes a task attribute that is common for all employers, such as the task price, and compares the associated task attribute values to determine an employer ranking order. The contents of task attribute database 5B or task database 5 can subsequently be rearranged to reflect this employer ranking order. Preferably, the employer ranking algorithm determines the employer ranking order based on the task price. Higher task prices will generally achieve a higher ranking order.

Based on the employer ranking order, a predefined delay between the moment of creation and/or modification of the task object and the availability of the task object to future workers is calculated by task access unit 17. This unit receives information from task object unit 13 regarding the moment of creation/modification of a given task object. Additionally or alternatively, this information is contained in the task object itself. Task access unit further obtains a current time and date from task timer 16. When the calculated delay is equal to or less than the current time and date minus the time and date of creation/modification, task access unit 17 makes the particular task object available to future workers.

It should be obvious to the skilled person that other ways are possible to implement this delay function. For instance, task access unit 17 can be configured to make the task object available once a new/modified task signal is received from task object unit 13. Instead of having a direct connection between task object unit 13 and task access unit 17, a delay can be incorporated in between to delay the task signal by an amount calculated based on the ranking order.

Next, an example is given to illustrate the process of publishing task objects in task database 5.

A company/employer named “working inc.” creates an account on work distribution system 1. The account is registered in the name of “employer A” so that future workers cannot determine the true name of “employer A”. The account may further comprise other information not accessible to the future worker such as billing information, address, contact persons, phone numbers, etc.

In addition to “employer A”, another company/employer named “holiday inc.” creates an account on work distribution system 1 registered in the name of “employer B”.

Next, parts of the content of position database 6 and skill database 7 are shown.

TABLE 1
Example content of position database 6 and skill database 7.

| Entry number | Job position object | Skill object |
|---|---|---|
| 1 | translator | Translate EN−>FR |
| 2 | web designer | Translate FR−>EN |
| 3 | programmer | C++ programming |
| 4 | logistics consultant | HTML programming |
| 5 | electronics designer | JAVA programming |

Entries having identical entry numbers are generally not correlated.

“Employer A” has open positions for a translator for translating texts between English (EN) and French (FR). Therefore, the skills “Translate EN→FR” and “Translate FR→EN” are selected from skill database 7 in addition to or instead of the “translator” job position object in position database 6. This process is conducted using the employer registering unit 12.

Next, “employer A” will associate at least one task attribute with the selected skill objects and/or job position object. Parts of the content of database 14 having predefined task attributes are shown next:

TABLE 2
Example contents of database 14.

| Entry number | Task attribute |
|---|---|
| 1 | Task price |
| 2 | Location |
| 3 | Delivery time |
| 4 | Skill level |
| 5 | Experience |
| 6 | Number of available positions |

For each selected task attribute of database 14, “employer A” indicates a desired task attribute value. An important task attribute in this respect is the task price. This process can be repeated for all selected skill objects.

At this point in the process, employer ranking unit 15 can rank the task attributes in task attribute database 5, 5B. That is, prior to the employer defining a task object, an employer ranking order may be determined. Such employer ranking order is normally based on the task price pertaining to a particular skill. After establishing the employer ranking order, the employer can define a task object using task object unit 13. However, the employer may be presented with the opportunity to modify a task attribute and/or task attribute value in view of feedback on the employer ranking order. For instance, after having indicated a certain task price, the employer may be informed by work distribution system 1 that his employer ranking is bad. In other embodiments the employer ranking order is notified as is. Using this information, the employer can modify the task price to try and improve the employer ranking order. Once a satisfactory employer ranking order is obtained, the employer may continue to define task objects using the selected skill objects and/or job position objects.

The selected skill objects and job position objects, as well as the corresponding task attributes and task attributes values can be incorporated into a task object generated by the task object unit 13. This allows the employer ranking unit 15 to determine the employer ranking using the information in the task object itself, for instance the task price. This allows the ranking process to continue even after the task object has been created. It may even be possible to first determine the employer ranking order after having created the task object. This further illustrates the possibility that an employer continues to receive feedback on the employer ranking order pertaining to an existing task object thereby allowing the employer to change his position.

In addition to skill objects, job position objects, and task attribute (values), “employer A” can indicate a task description and include the date of creation/update task attribute.

Selecting the task attributes and assigning task attribute values to them, either relating to a selected skill object and/or job position object, can be performed by the employer registering unit 12 and/or the task object unit 13.

Once the task object is fully defined it is entered in task database 5. Possible entries in task database 5 are given next:
Task name: Task 1 employer A
Created/modified: 12, Oct. 2010, 13:10
Employer name: Employer A
Task description: Translate legal documents between English and French.
Required skills:

Translate EN→FR skill level 3

Translate FR→EN skill level 2
Experience: 10 previous assignments
Task price: 0.20 dollar cent for each word.
Number of available positions: 2
Location: to be determined by worker
Delivery time: finished before 20, Oct. 2010, 12:00
Task name: Task 2 employer A
Created/modified: 14, Oct. 2010, 13:10
Employer name: Employer A
Task description: Design web site for patent attorney firm
Required skills:

C++ programming skill level 4

HTML programming skill level 3
Task price: 3000 dollar.
Number of available positions: 1
Location: to be determined by worker
Delivery time: finished before 24, Oct. 2010, 15:00
Task name: Task 1 employer B
Created/updated: 12, Oct. 2010, 15:10
Employer name: Employer B
Task description: Translate legal documents between

English and French.
Required skills:

Translate EN→FR skill level 2

Translate FR→EN skill level 1
Experience: 7 previous assignments
Task price: 0.19 dollar cent for each word.
Number of available positions: 4
Location: Employer A premises.
Delivery time: finished before 25, Oct. 2010, 11:00

In the present example, the employer ranking order is determined on the basis of the task price only, wherein the highest task price achieves the highest employer ranking order.

Next, task access unit 17 receives the creation/modification information from task object unit 13, or this information is taken from the task object itself. It also receives the employer ranking order from employer ranking unit 15, and the current time and date from task timer 16.

Task access unit 17 then determines the delay applicable for each task object for allowing access by future workers to the task objects in task database 5, 5A. This delay is determined in accordance with a delay calculation algorithm that depends on the received employer ranking order. An example of a delay calculation algorithm is given in the next table.

TABLE 3
Delay calculation.

| Ranking order | Delay |
|---|---|
| Top 25% | None |
| Top 50% − Top 25% | 24 hours |
| Bottom 25% − Bottom 50%/Top 50% | 48 hours |
| Bottom 25% | 72 hours |

According to this algorithm, when taken in combination with the employer ranking algorithm, companies/employers with the highest task price will have their task objects available to future workers without delay. However, companies/employers with the lowest task price will have to wait for 72 hours after the date of creation/update of the task object for it to be available to future workers.

Other task attributes and associated task attribute values can also be used for calculating the employer ranking order. For example, the delivery time could be included. A higher requested delivery time could lower the employer ranking order. In other words, if an employer requires a task/work to be completed on short notice, it must increase the task price to compensate for the short delivery times if it wishes to achieve a high employer ranking order.

It is not required that the employer ranking algorithm takes into account every task attribute and/or task attribute value associated with a task object, skill object and/or job position object. For instance, with task 1 employer A, the algorithm could disregard the experience task attribute. In that case, such parameter is provided for information purposes only. However, it may also be used to limit accessibility to the task object from the side of the future worker, as will be described in more detail later.

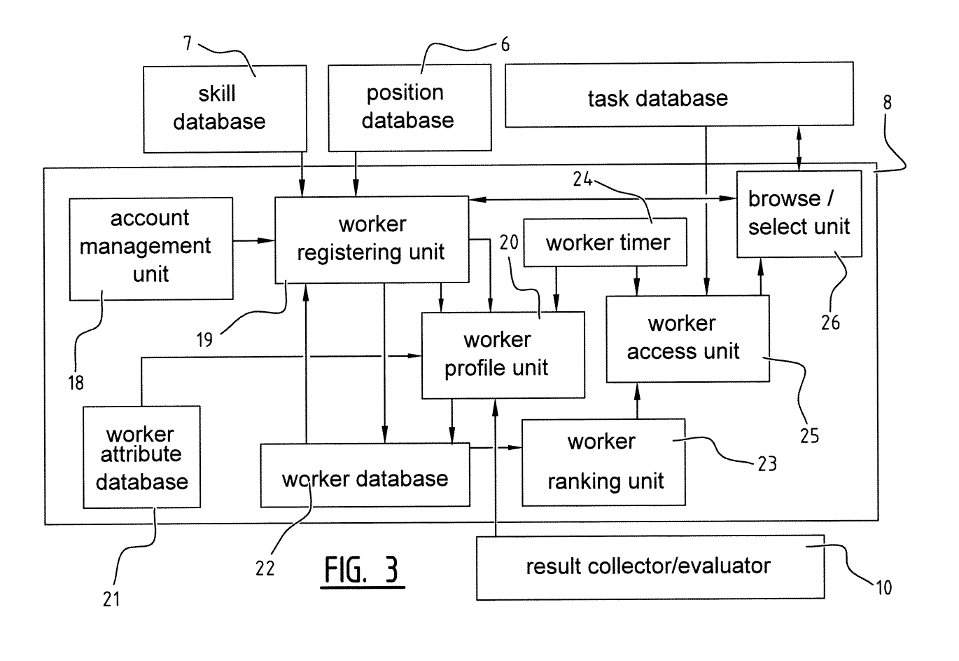

FIG. 3 illustrates worker module 8 in more detail. It comprises an account management unit 18 which allows a future worker to perform account management functions. For instance, a new future worker can set up an account and include particulars thereof such as user name, contact information, billing information etc.

Once a future worker has created an account he or she can register to a particular skill object or job position object using worker registering unit 19. Similar to employer register module 12, position database 6 and skill database 7 can be browsed to select from the various items contained in those databases. By registering to a job position object and/or skill object, a worker can subsequently define a worker profile using worker profile unit 20. A worker profile can therefore correspond to a particular job position object and/or skill object. A worker can assign worker attributes to the created worker profile. These worker attributes can be picked from a worker attribute database 21 and worker attribute values can be assigned to them. An important worker attribute is the work price, which is the amount the future worker will receive from an intermediary for doing a task/work.

If a future worker registers to a particular job position object and/or skill object, he will generally only be able to choose from task objects in task database 5, 5A which relate to the registered job position object(s) and/or skill object(s). This allows a future worker to narrow down the search within task database 5, 5A.

Once the worker profile is associated with the worker attributes and values are assigned to the worker attributes, the worker profile is put in worker database 22. However, putting the worker profile in worker database 22 does not necessarily imply that the future workers involved can directly access the task objects in task database 5, 5A. Instead, a worker ranking unit 23, a worker timer 24, and a worker access unit 25 are used to delay the access of a future worker to task database 5.

Given the worker profile, and more in particular the various task attributes and task attribute values, worker ranking unit 23 determines the worker ranking order of the worker profile of a future worker among those of other work profiles and/or other future workers using a worker ranking algorithm. The worker ranking algorithm takes a worker attribute that is common for the worker profiles in the worker database, such as the work price, and compares the associated worker attribute values to determine a worker ranking order.

Once a worker ranking order has been established by worker ranking unit 23, a worker access unit 25 determines whether, to which, and at what time, a future worker can see a particular task object in task database 5, 5A for him or her to claim. To this end, worker access unit 25 will calculate a predefined time period based on the worker ranking order determined by worker ranking unit 23. Next, worker access unit 25 determines, based on the creation/modification time of the task object, a current time and date obtained from worker timer 24, whether access for the future worker to the task object should still be delayed.

When access is no longer delayed, the future worker can browse through task database 5, 5A using browse/select unit 26 thereby only seeing tasks for which he has registered to the appropriate skill object and/or job position object. The delay is normally computed from the moment of creation of the relevant task object.

The computation of the worker ranking order can be performed just after the future worker has specified a specific task attribute value, such as the work price. It need not wait before the creation of the worker profile is completed.

It is possible that multiple common worker attributes can be identified. In such a case, the worker ranking algorithm may determine a separate worker ranking order for each common worker attribute based on the relevant worker attribute values. A weighing scheme may then be used to determine the worker ranking order of the worker profile. Instead of weighing a different approach can be followed. For instance it may be possible to determine a separate worker ranking order for each common worker attribute and use this separate worker ranking order to calculate a separate delay. The overall delay is then the sum of all separate delays relating to the different common worker attributes.

If a future worker is interested in a particular task object he can claim the task object using browse/select unit 26. Subsequently, task object unit 13 is informed about this change. This unit may in turn reduce the number of positions available by changing the task attribute value of the available positions task attribute of the task object. If only one position was available, the relevant task object can be removed from task database 5, 5A. However, if more positions were available, task object unit 13 can reduce the appropriate task attribute value by one. Instead of specifying the number of positions that are available, an employer may also choice to define multiple task objects.

When the worker has finished his work, he can transfer his results to result collector/evaluator 10. The relevant employer can be informed about the fact that the work is finished and that the results can be downloaded from result collector/evaluator 10.

The employer can evaluate the results and report back to the result collector/evaluator 10 for instance in the form of a quality indicator. Using this quality indicator, result worker profile unit 20 can modify the worker profile. If a worker performs badly on a task, the worker profile of this worker may be adapted such that the skill level attribute value is decreased. Consequently, the worker could be only able to work on tasks having a lower skill level.

Next, an example is given to illustrate the process of claiming a task object in task database 5.

A future worker named “Mr. Blue” creates an account on work distribution system 1. The account is registered in the name of “blue sky” so that employers cannot determine the true name of “Mr. Blue”. The account may further comprise other information not accessible to employers such as billing information, address, contact persons, phone numbers, etc.

In addition to “Mr. Blue”, another future worker named “Mr. White” creates an account on work distribution system 1 registered in the name of “snow flake”.

At this point, both future workers can select the various job position objects and/or skill objects they are interested in from position database 6 and/or skill database 7. This information can be stored in a worker profile by worker profile unit 20. In addition, a future worker can select worker attributes from worker attribute database 21 and assign values to them.

Selecting the worker attributes and assigning worker attribute values to them, either relating to a selected skill object and/or job position object, can be performed by the worker registering unit 19 and/or the worker profile unit 20.

Parts of the content of worker attribute database 21 are shown next:

TABLE 4
Example contents of worker attribute database 21.

| Entry number | Parameter database item |
|---|---|
| 1 | Work price |
| 2 | Location |
| 3 | Availability |
| 4 | Skill level |
| 5 | Experience |

The most important worker attribute is the work price, which is the amount of money the future worker will receive when completing a task/work. This worker attribute could be assigned various values depending on the relevant skill object and/or job position object. For instance, when designing websites, the work price could be in the form of dollar/hour or a lumped sum, whereas for translation skill objects the work price is in dollar cents/word. It is possible that for a given task object, a future worker or an employer specifies multiple prices in multiple formats depending on the skill objects involved.

In addition to worker attributes, “employer A” can indicate a task description and include a date of creation/modification of the worker profile.

Once the worker profile is fully defined it is entered in worker database 22. In a further embodiment, an employer can browse through this database in order to select a particular worker for a given task.

Possible worker profiles for the abovementioned workers are given next.
Worker name: Mr. White
User name: Snow flake
Profile Created/modified: 12, Oct. 2010, 13:10
Registered Positions: Translator
Registered skills:

Translate EN→FR skill level 5

Translate FR→EN skill level 4
Experience: 10 previous assignments
Task bid: 0.15 dollar cent for each word.
Location: Works at home
Availability: From 1, Nov. 2010 onwards.
Employee name: Mr. Blue
User name: blue sky
Created/updated: 12, Oct. 2010, 13:10
Registered Positions: Web designer
Registered skills:

C++ programming skill level 4

HTML programming skill level 3
Task bid: 2000 dollar.
Location: Willing to relocate
Availability: From 15, Nov. 2010 onwards.

When Mr. White registers to the job position object “translator” and registers to the skill objects “translate EN→FR” and “translate FR→EN” he will be able to see “task 1 employer A” in task database 5. However, from the moment of creation of that task, it may take some time until Mr. White can actually see this task object. Firstly, as described above, a delay may be caused by employer A, which for instances offers a low price resulting in a low employer ranking order of the task object. Secondly, a delay may be imposed by worker access unit 25, which calculates a delay based on the worker ranking order of the worker attribute, such as work price, of Mr. White in the worker database 22. An example of this calculation is given next.

TABLE 5
Delay calculation based on work price ranking order

| Worker ranking order | Delay |
|---|---|
| Top 25% | 72 hours |
| Top 50% − Top 25% | 48 hours |
| Bottom 25% − Bottom 50%/Top 50% | 24 hours |
| Bottom 25% | None |

TABLE 6
Delay calculation based on skill level ranking order

| Worker ranking order | Delay |
|---|---|
| Top 25% | None |
| Top 50% − Top 25% | 24 hours |
| Bottom 25% − Bottom 50%/Top 50% | 48 hours |
| Bottom 25% | 72 hours |

In this case, delay is determined using two different worker attributes, i.e. the work price and the skill level. The total delay is computed by adding the two separate delay periods. For instance, a very high work price in combination with a low skill level attribute value could result in a total delay of 144 hours. Hence, even if the relevant employer has a very high ranking order, e.g. the task price is extremely high, the worker risks not being able to see and claim the task object in time because of the adverse worker profile. He thus risks losing the task object to a competitor. To solve this issue, a future worker can update his worker profile to influence the worker ranking order for the various worker attributes in view of feedback on the worker ranking order received from work distribution system 1.

In the example above, Mr. White can claim the task object “task 1 employer A”. However, he cannot see the task price corresponding to this task object. Similarly, company A cannot see the work price of Mr. White, thereby obtaining a double blind process. The fact that Mr. White can see the task object does however in most cases imply that his work price is less than the task price minus a possible surcharge. The surcharge can also be levied on the worker's side. In such case, the task price minus a surcharge is greater than or equal to the work price plus a surcharge.

In both cases, the surcharge is for the benefit of the intermediary offering the work distribution system according to the present invention.

Even without surcharges, there might be a mismatch between the task price and the work price. For instance, in the present case the task price (0.20 dollar cent/word) is much higher than the work price (0.15 dollar cent/word). Also in this case, the surplus, being the task price minus the work price (0.05 dollar cent/word), may be for the benefit of the intermediary.

In other embodiments, a future worker is able to browse task objects in the task database regardless the task price or work price. In such embodiment, the task price is visible to the future worker. By claiming a task object, the future worker commits to carrying out the associated work for the given price. However, this price may also include a surcharge for the benefit of the intermediary as discussed above.

In most cases, the receipt intermediary receiving payment from the employers, the payment intermediary paying the future workers, and the intermediary offering the work distribution system of the present invention will at least belong to the same organisational structure and in most cases will be the same intermediary.

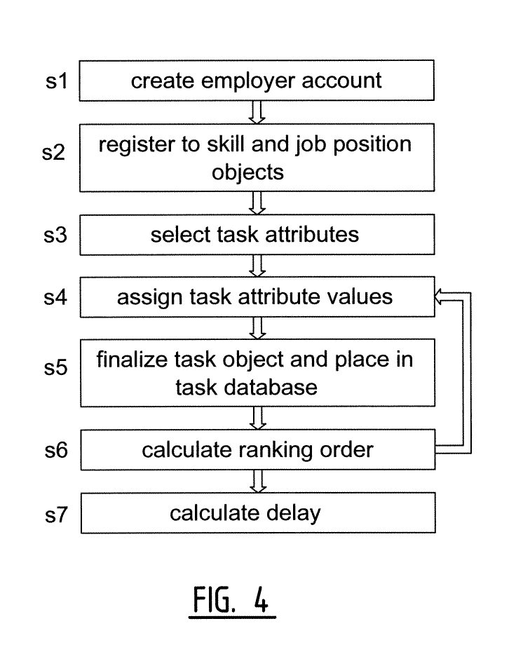

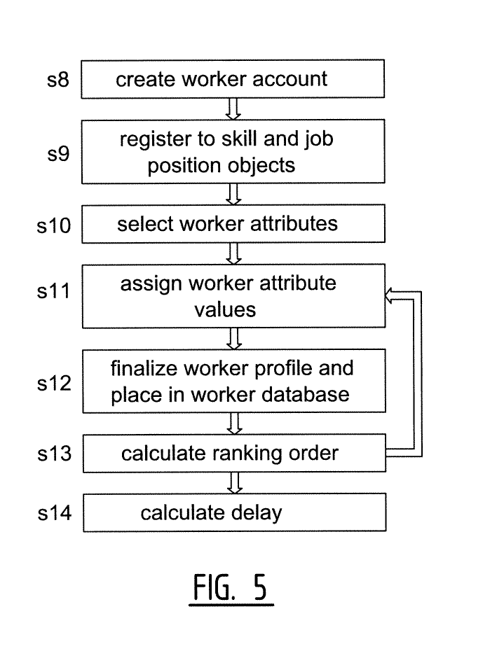

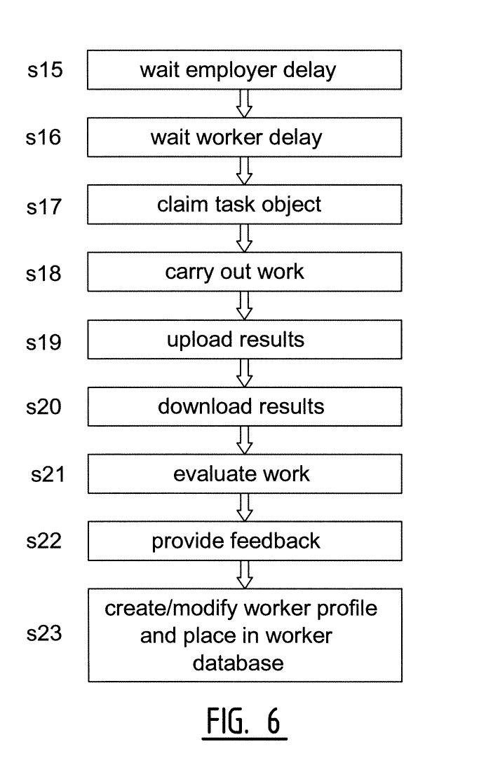

FIGS. 4, 5, and 6 illustrate an example of an implementation of a method of distributing work according to the present invention. FIG. 4 shows the process on the side of the employer, FIG. 5 the process on the side of the future worker, and FIG. 6 combines both processes.

First, in step S1, an employer creates an account with the system and logs in, see FIG. 4. In step S2, the employer registers to one or more skill object(s) and/or one or more job position object(s), which are taken from skill database 7 and position database 6, respectively. In step S3, the employer selects appropriate task attributes from database 14 having predefined task attributes. In step S4, the employer assigns appropriate task attribute values to the selected task attributes. This completes the generation of the task object, which is then placed in task database 5, 5A in step S5. An employer ranking order is determined for the newly created task object in step S6. In step S7, the determined employer ranking order is used to calculate a suitable delay for access to task database 5, 5A. As indicated by the arrow, the employer may repeat steps S4-S6 to obtain a better employer ranking order.

In another thread of the process, in step S8, a future worker creates an account with system 1 and logs in, see FIG. 5. In step S9, the future worker registers to one or more skill object(s) and/or one or more job position object(s), which are taken from skill database 7 and position database 6, respectively. In step S10, the future worker selects appropriate worker attributes from worker attribute database 14. In step S11, the future worker assigns appropriate worker attribute values to the selected worker attributes. This completes the generation of the worker profile, which is then placed in worker database 22 in step S12. A worker ranking order is determined for the newly created worker profile in step S13. In step S14, the determined worker ranking order is used to calculate a suitable delay for access to the task database. As indicated by the arrow, the worker may repeat steps S11 to S13 to obtain a better worker ranking order.

In steps S15 and S16, the access to task database 5, 5A is delayed using the delays calculated in steps S7 and S14, respectively, see FIG. 6. After the delay, the future worker can select the task object in step S17. The future worker may then carry out the work, S18. After he has completed the work he can upload the results to the work distribution system in step S19. The relevant company/employer is informed and may subsequently download the results in step S20. The employer may evaluate the work done by the future worker in step S21. Following the evaluation, the employer may provide feedback to work distribution system 1 regarding the performance of the future worker in step S22. In step S23, this feedback is used to modify the worker profile, and more in particular the skill level worker attribute value, to reflect the performance of the worker.

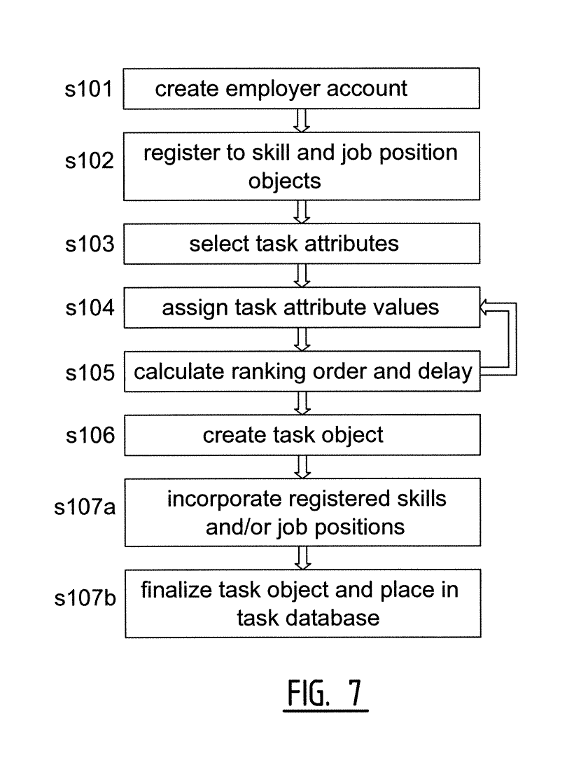

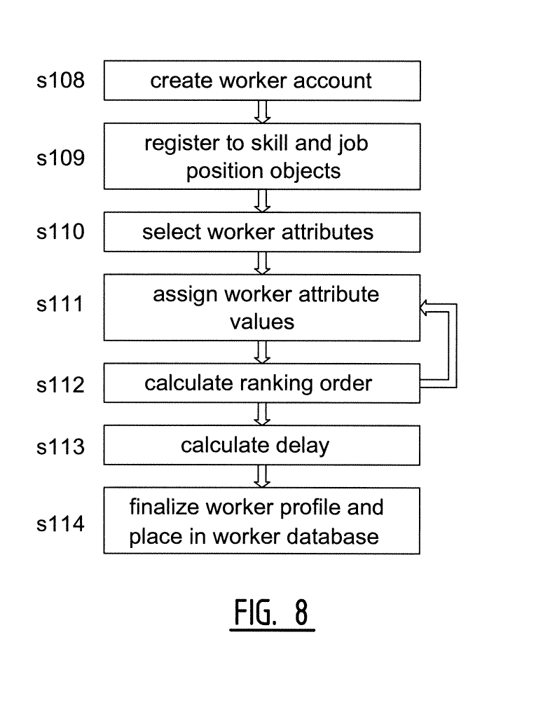

FIGS. 7 and 8 illustrate a further example of an implementation of a method of distributing work according to the present invention. FIG. 7 shows the process on the side of the employer, and FIG. 8 the process on the side of the future worker. The steps in FIG. 6 can be used to complete the method illustrated in FIGS. 7 and 8.

First, in step S101, an employer creates an account with the system and logs in, see FIG. 7. In step S102, the employer registers to one or more skill object(s) and/or one or more job position object(s), which are taken from skill database 7 and position database 6, respectively. In step S103, the employer selects appropriate task attributes from database 14 having predefined task attributes. In step S104, the employer assigns appropriate task attribute values to the selected task attributes.

Next, in step S105, the employer ranking order is determined for the common task attributes in task attribute database 5, 5B and a associated delay is calculated. Here, steps S104 and S105 may be repeated if a better worker ranking order is desired.

Next, in step S106, a task object may be created in which, during step S107A, the registered skill and/or job position objects are incorporated. Subsequently, the finalized task object is placed in task database 5, 5A in step S107B.

In another thread of the process, in step S108, a future worker creates an account with the system and logs in, see FIG. 8. In step S109, the future worker registers to one or more skill object(s) and/or one or more job position object(s), which are taken from skill database 7 and position database 6, respectively. In step S110, the future worker selects appropriate worker attributes from worker attribute database 21. In step S111, the future worker assigns appropriate worker attribute values to the selected worker attributes. In step S112, a worker ranking order is determined in dependence of common worker attributes, such as work price. As indicated by the arrow, the worker is given the opportunity to modify a worker attribute to change his worker ranking order. Furthermore, in step S113, the determined worker ranking order is used to calculate a suitable delay for access to the task database. This completes the generation of the worker profile, which is then finalized and placed in a worker database in step S114.

Next, the steps already described in conjunction with FIG. 6 can be used to complete the distribution of work.

The main difference between the different methods illustrated in FIGS. 4-6, and FIGS. 7 and 8 is related to the moment at which the ranking order is determined, both on the employer side and the worker side. The former method illustrates a method in which the ranking is performed after a task object has been created. In other words, after an employer has specified the actual work to be done. FIGS. 7 and 8 depict another option in which the ranking is purely based on the price associated with a particular skill object or job position object. Both methods, as well as combinations thereof, are examples of the present invention.

In the description above, several embodiments of the present invention have been described. However, it should be apparent to the skilled person in the art that various modifications are possible without departing from the scope and spirit of the invention as described by the appended claims.

What is claimed is:

1. A work distribution system, comprising:
an employer module that is remotely controllable by an employer, said employer module having a task object unit for creating and/or modifying a task object that corresponds to work to be carried out for said employer by a future worker;
an employer database unit comprising a task database for storing a plurality of said task objects corresponding to a plurality of employers and further comprising a task attribute database for storing at least one task attribute and corresponding task attribute value for each of said plurality of employers, wherein one of said at least one task attribute is a task price related to a task object created or to be created by the task object unit and wherein the corresponding task attribute value is the magnitude of the task price;
a worker module that is remotely controllable by a future worker, said worker module comprising a browse/select unit for browsing said task database and for claiming a task object present therein to indicate that said future worker will carry out the work associated with said claimed task object;
wherein the employer module comprises an employer ranking unit arranged to determine an employer ranking order for each task price in the task attribute database using an employer ranking algorithm in dependence of the magnitude of the task price, and
wherein the employer module further comprises a task access unit arranged to delay the availability of a task object in the task database to a future worker by a predetermined time period after creating and/or modifying said task object in dependence of the corresponding determined employer ranking order.

2. The work distribution system according to claim 1, wherein the employer module is configured to provide information regarding the determined employer ranking order to the relevant employer, and to allow the relevant employer to change said at least one task attribute and/or corresponding task attribute value.

3. The work distribution system according to claim 1, wherein the employer ranking unit is arranged to determine said employer ranking order using an employer ranking algorithm in dependence of a plurality of task attribute values corresponding to a plurality of task attributes that are common to each of said plurality of employers, said employer ranking algorithm being configured to determine a separate employer ranking order for each of the common task attributes using the corresponding task attribute values and to determine said employer ranking order by weighing each separate employer ranking order according to a predefined weighing scheme.

4. The work distribution system according to claim 1, wherein the employer ranking unit is arranged to determine said employer ranking order using an employer ranking algorithm in dependence of a plurality of task attribute values corresponding to a plurality of task attributes that are common to each of said plurality of employers, said employer ranking algorithm being configured to determine a separate employer ranking order for each of the common task attributes using the corresponding task attribute values, wherein the task access unit is arranged to determine a separate predetermined time period for each common task attribute in dependence of the relevant separate employer ranking order, and wherein the task access unit is arranged to delay the availability of a task object in the task database to a future worker by the sum of the separate predetermined time periods after creating and/or modifying said task object.

5. The work distribution system according to claim 1, wherein the task price corresponds to the amount of money the relevant employer will pay to a receipt intermediary for carrying out said work by the future worker, and wherein the employer ranking order is determined to be higher when the task price is higher than those corresponding to other employers, and wherein said delay in making said task object available to a future worker decreases with increasing employer ranking order.

6. The work distribution system according to claim 1, wherein the worker module comprises a worker profile unit for creating a worker profile comprising at least one worker attribute with a corresponding worker attribute value, said work distribution system further comprising a worker database for storing a plurality of said worker profiles corresponding to a plurality of workers, wherein one of said at least one worker attribute is a work price related to the work to be carried out and wherein the corresponding worker attribute value is the magnitude of the work price;
wherein the worker module further comprises a worker ranking unit arranged to determine a worker ranking order for each work price in the worker database using a worker ranking algorithm in dependence of the magnitude of the work price, and
wherein the worker module comprises a worker access unit arranged to delay the availability of a task object in the task database to a future worker by a predetermined time period in dependence of the determined worker ranking order.

7. The work distribution system according to claim 6, wherein the worker module is configured to provide information regarding the determined worker ranking order to the future worker, and to allow the future worker to change said at least one worker attribute and/or corresponding worker attribute value.

8. The work distribution system according to claim 6, wherein the worker ranking unit is arranged to determine the worker ranking order using a worker ranking algorithm in dependence of a plurality of worker attribute values corresponding to a plurality of worker attributes that are common to each of said plurality of workers, said worker ranking algorithm being configured to determine a separate worker ranking order for each of the common worker attributes using the corresponding worker attribute values and to determine the worker ranking order by weighing each separate worker ranking order according to a predefined weighing scheme.

9. The work distribution system according to claim 6, wherein the worker ranking unit is arranged to determine the worker ranking order using a worker ranking algorithm in dependence of a plurality of worker attribute values corresponding to a plurality of worker attributes that are common to each of said plurality of workers, said worker ranking algorithm being configured to determine a separate worker ranking order for each of the common worker attributes using the corresponding worker attribute values, wherein the worker access unit is arranged to determine a separate predetermined time period for each common worker attribute in dependence of the relevant separate worker ranking order, and wherein the worker access unit is arranged to delay the availability of a task object in the task database to a future worker by the sum of the separate predetermined time periods after creating and/or modifying said task object.

10. The work distribution system according to claim 6, further comprising a skill database comprising skill objects representing skills needed by a future worker for carrying out said work, and/or a position database comprising job position objects representing job positions relating to said work;
wherein said employer module comprises an employer registering unit for selecting a skill object from said skill database and/or a job position object from said position database, and to mutually associate the objects and a created or to be created task object;
wherein said worker module comprises a worker registering unit for registering to a skill object from said skill database and/or for registering to a job position object from said position database, wherein the worker access unit is configured for making available to a future worker only those task objects for which an associated skill object and/or job position object corresponds to a skill object and/or job position object registered by said future worker; and
wherein said task price and said work price preferably correspond to the selected skill object.

11. The work distribution system according to claim 6, wherein the task price corresponds to the amount of money the relevant employer will pay to a receipt intermediary for carrying out said work by the future worker and wherein said work price is the amount of money the relevant worker will receive from a payment intermediary for carrying out said work, wherein the worker access unit is configured to make available to a future worker only those task objects for which the task price minus a surcharge is higher than or equal to the relevant work price pertaining to said future worker, and wherein said work price is preferably not visible for the employer and/or wherein said task price is preferably not visible for the future worker, said receipt intermediary and said payment intermediary being identical and the surcharge being for the benefit of the intermediary.

12. A method for distributing work, comprising in arbitrary order:
storing at least one task attribute and corresponding task attribute value for each of a plurality of employers in a task attribute database, wherein one of said at least one task attribute is a task price related to work to be carried out by a future worker for an employer and wherein the corresponding task attribute value is the magnitude of the task price;
an employer creating and/or modifying a task object that corresponds to the work to be carried out for said employer by said future worker;
storing a plurality of said task objects corresponding to a plurality of employers in a task database, wherein said task database can be browsed by a future worker and wherein a future worker can claim a task object therein to indicate that said future worker will carry out the work associated with said claimed task object;
wherein the method further comprises the steps of:
determining an employer ranking order for each task price in the task attribute database using an employer ranking algorithm in dependence of the magnitude of the task price, and
delaying the availability of a task object in the task database to a future worker by a predetermined time period after creating and/or modifying said task object in dependence of the determined employer ranking order.

13. The method according to claim 12, further comprising:
providing information regarding the determined employer ranking order to the relevant employer; and
allowing the relevant employer to change said at least one task attribute and/or corresponding task attribute value.

14. The method according to claim 12, wherein the determination of the employer ranking order comprises:
determining the employer ranking order using an employer ranking algorithm in dependence of a plurality of task attribute values corresponding to a plurality of task attributes that are common to each of said plurality of employers;
said employer ranking algorithm comprising the steps of determining a separate employer ranking order for each of the common task attributes using the corresponding task attribute values, and determining said employer ranking order by weighing each separate employer ranking order according to a predefined weighing scheme.

15. The method according to claim 12, wherein the determination of the employer ranking order comprises:
determining the employer ranking order using an employer ranking algorithm in dependence of a plurality of task attribute values corresponding to a plurality of task attributes that are common to each of said plurality of employers;
said employer ranking algorithm comprising the step of determining a separate employer ranking order for each of the common task attributes using the corresponding task attribute values;
wherein said delaying of the availability of a task object in the task database to a future worker comprises:
determining a separate predetermined time period for each common task attribute in dependence of the relevant separate employer ranking order;
delaying the availability of a task object in the task database to a future worker by the sum of the separate predetermined time periods after creating and/or modifying said task object.

16. The method according to claim 12, further comprising:
the employer selecting a skill object from a skill database and/or a job position object from a position database;
the employer selecting said at least one task attribute from a database with available predefined task attributes, said at least one task attribute including said task price, wherein said task price is related to the selected skill object and/or job position object;
the employer assigning a task attribute value to said selected task attribute and storing said task attribute and said task attribute value assigned thereto in said task attribute database prior to said employer creating and/or modifying said task object, and wherein the employer ranking order is determined prior to said employer creating and/or modifying said task object.

17. The method according to claim 12, further comprising:
the employer selecting a skill object from a skill database and/or a job position object from a position database;
the employer selecting said at least one task attribute from a database with available predefined task attributes, said at least one task attribute including said task price, wherein said task price is related to the selected skill object and/or job position object;
the employer assigning a task attribute value to said selected task attribute and storing said task attribute and said task attribute value assigned thereto in said task attribute database after said employer creating and/or modifying said task object;
incorporating the selected task attribute and assigned task attribute value into the created and/or modified task object;
ranking the task objects in the task database using the employer ranking order.

18. The method according to claim 12, further comprising:
the future worker creating a worker profile comprising at least one worker attribute with a corresponding worker attribute value, wherein one of said at least one worker attribute is a work price related to the work to be carried out and wherein the corresponding worker attribute value is the magnitude of the work price;
storing a plurality of said worker profiles corresponding to a plurality of workers in a worker database;
determining a worker ranking order for each work price in the worker database using a worker ranking algorithm in dependence of the magnitude of the work price;
delaying the availability of a task object in the task database to a future worker by a predetermined time period in dependence of the determined worker ranking order;
the method further comprising:
providing information regarding the determined worker ranking order to the relevant future worker; and
allowing said relevant future worker to change said at least one worker attribute and/or corresponding worker attribute value.

19. The method according to claim 18, wherein the determination of the worker ranking order for each work price comprises:
determining the worker ranking order using a worker ranking algorithm in dependence of a plurality of worker attribute values corresponding to a plurality of worker attributes that are common to each of said plurality of workers;
said worker ranking algorithm comprising the steps of determining a separate worker ranking order for each of the common worker attributes using the corresponding worker attribute values and to determine said worker ranking order by weighing each separate worker ranking order according to a predefined weighing scheme.

20. The method according to claim 18, wherein the determination of the ranking order comprises:
determining a worker ranking order using a worker ranking algorithm in dependence of a plurality of worker attribute values corresponding to a plurality of worker attributes that are common to each of said plurality of workers;
said worker ranking algorithm comprising the step of determining a separate worker ranking order for each of the common worker attributes using the corresponding worker attribute values;
wherein said delaying the availability of a task object in the task database to a future worker comprises:
determining a separate predetermined time period for each common worker attribute in dependence of the relevant separate worker ranking order; and
delaying the availability of a task object in the task database to a future worker by the sum of the separate predetermined time periods after creating and/or modifying said task object.
